(19) United States
(12) Patent Application Publication
(10) Pub. No.: US 2025/0282568 A1
(43) Pub. Date: Sep. 11, 2025

(54) FORMATION OF SHEET STACKS BY MEANS OF A SHEET-PROCESSING APPARATUS

(71) Applicant: GIESECKE+DEVRIENT CURRENCY TECHNOLOGY GMBH, Munchen (DE)

(72) Inventor: Markus SPERL, Straubing (DE)

(21) Appl. No.: 18/859,745

(22) PCT Filed: Apr. 27, 2023
(86) PCT No.: PCT/DE2023/100306

§ 371 Date: Oct. 24, 2024

(30) Foreign Application Priority Data
May 3, 2022 (DE) 10 2022 001 543.9

(51) Int. Cl. B65H 29/40; B65G 47/90; B65H 31/08; B65H 31/30; G07D 11/12; G07D 11/16; G07D 11/50

(52) U.S. Cl. CPC B65H 29/40; B65G 47/90; B65H 31/08; B65H 31/3036; G07D 11/135; G07D 11/16; B65H 2301/42124; B65H 2301/4224; B65H 2301/4225; B65H 2701/1912; G07D 11/50; G07D 2211/00

(57) ABSTRACT

A method for forming sheet stacks in a dispensing region of a sheet processing apparatus, involves: a) stacking sheets by a stacker wheel onto a sheet stack located on a lifting platform, b) introducing a deposition platform into the dispensing region, c) stacking further sheets by the stacker wheel onto the deposition platform arranged underneath the stacker wheel, d) introducing a gripping device into the dispensing region to take up, by the gripping device, the sheet stack formed on the lifting platform, e) removing the sheet stack formed on the lifting platform from the dispensing region, and, after the removal of the sheet stack, f) raising the lifting platform up to the deposition platform, and g) transferring the further sheet stack formed on the deposition platform onto the lifting platform and moving the deposition platform away out of the dispensing region.

The invention relates to a method for forming sheet stacks, in particular stacks of documents of value, by means of a sheet processing apparatus, in particular processing apparatus for documents of value, and to a sheet processing apparatus, in particular processing apparatus for documents of value, which is set up to carry out the method.

Cash/valuables-in-transit companies or central banks are involved in processing, e.g. checking, sorting, counting and stacking, a multiplicity of documents of value using processing apparatuses for documents of value. The stacks of documents of value formed in the process are, for storage and/or transport purposes, usually filled into containers for documents of value that are provided for this.

In processing apparatuses for documents of value, the documents of value are separated from a stack of documents of value and carried past sensors on a transport line. The individual documents of value are verified by the sensors and, depending on the result of the verification, are fed to specific target locations of the apparatus, e.g. dispensing compartments. The verified documents of value are fed to the stacker wheel in the apparatus. The stacker wheel rotates, such that the compartments are individually filled with a respective document of value. An ejector is used to eject the documents of value from the compartments of the stacker wheel and thus form a stack of documents of value, which is dispensed from the processing apparatus for documents of value.

It is also known practice for a stack of documents of value dispensed in a dispensing region of a processing apparatus for documents of value to be removed by means of a gripper from the dispensing region and placed in a container for documents of value which has been positioned within reach of the gripper. A disadvantage of this is that the stacking performed by the stacker wheel must be halted for lengthy periods for the gripper to be able to remove the stack of documents of value. This is because the stacker wheel can only start again with the stacking of a further stack of documents of value when the previous stack of documents of value has been removed by the gripper from the dispensing region of the processing apparatus for documents of value. The lengthy interruption of the stacking reduces the throughput of documents of value of the processing apparatus for documents of value.

Similarly, it is also possible in the case of the formation of other sheet stacks that are not stacks of documents of value, such as stacks of sheet-like electrode elements, for the removal of a previous stack of electrode elements, this requiring the stacking to be interrupted, to cause a reduced throughput of the apparatus which processes, or stacks, the sheet-like electrode elements.

An object of the present invention is to increase the sheet throughput, in particular throughput of documents of value, of the sheet processing apparatus, in particular apparatus for processing documents of value.

This object is achieved by the method and the sheet processing apparatus, in particular processing apparatus for documents of value, according to the independent claims.

According to a first aspect of the present disclosure, a method for forming sheet stacks, in particular stacks of documents of value, in a dispensing region of a sheet processing apparatus, in particular a processing apparatus for documents of value, comprises the following steps:
a) stacking sheets/documents of value by means of a stacker wheel of the sheet processing apparatus/processing apparatus for documents of value onto a sheet stack/stack of documents of value located on a lifting platform,
b) introducing a deposition platform into the dispensing region of the sheet processing apparatus/processing apparatus for documents of value, wherein the deposition platform is introduced such that the deposition platform is arranged in a position which is underneath the stacker wheel and lies above the uppermost sheet/document of value of the sheet stack/stack of documents of value formed on the (possibly lowered) lifting platform,
c) stacking further sheets/documents of value by means of the stacker wheel onto the deposition platform arranged underneath the stacker wheel, in order to form a further sheet stack/stack of documents of value on the deposition platform,
d) introducing a gripping device into the dispensing region of the sheet processing apparatus/processing apparatus for documents of value, in order to take up, by means of the gripping device, the sheet stack/stack of documents of value formed on the lifting platform,
c) removing, by means of the gripping device, the sheet stack/stack of documents of value formed on the lifting platform from the dispensing region of the sheet processing apparatus/processing apparatus for documents of value, and, after the removal of the sheet stack/stack of documents of value,
f) raising the lifting platform up to the deposition platform, and
g) transferring the further sheet stack/stack of documents of value formed on the deposition platform onto the lifting platform and moving the deposition platform away out of the dispensing region.

According to a second aspect of the present disclosure, a sheet processing apparatus, in particular processing apparatus for documents of value, is set up to form sheet stacks, in particular stacks of documents of value, in a dispensing region of the sheet processing apparatus/processing apparatus for documents of value. The sheet processing apparatus/processing apparatus for documents of value has a stacker wheel, a lifting platform, a deposition platform, a control device and a gripping device, wherein the sheet processing apparatus/processing apparatus for documents of value is set up to stack sheets/documents of value processed by the sheet processing apparatus/processing apparatus for documents of value onto a sheet stack/stack of documents of value which is located on the lifting platform and underneath the stacker wheel in the dispensing region of the sheet processing apparatus/processing apparatus for documents of value. The control device is set up to cause, preferably at a point in time while the stacking by means of the stacker wheel is interrupted, the deposition platform to be introduced into the dispensing region of the sheet processing apparatus/processing apparatus for documents of value such that the deposition platform is arranged in a position which is underneath the stacker wheel and lies above the uppermost sheet/document of value of the sheet stack/stack of documents of value formed on the (possibly lowered) lifting platform. Moreover, the sheet processing apparatus/processing apparatus for documents of value is set up to stack, after the introduction of the deposition platform into the dispensing region, further sheets/documents of value processed by the sheet processing apparatus/processing apparatus for documents of value onto the deposition platform arranged underneath the stacker wheel, in order to form a further sheet stack/stack of documents of value on the deposition platform. Moreover, the control device is set up to cause the gripping device to be introduced into the dispensing region of the sheet processing apparatus/processing apparatus for documents of value, in order for the sheet stack/stack of documents of value to be taken up by means of the gripping device, and to cause the gripping device to remove the sheet stack/stack of documents of value formed on the lifting platform from the dispensing region of the sheet processing apparatus/processing apparatus for documents of value, and to cause, after the removal of the sheet stack/stack of documents of value formed on the lifting platform, the lifting platform to be raised up to the deposition platform, the further sheet stack/stack of documents of value formed on the deposition platform to be transferred onto the lifting platform, and the deposition platform to be moved away out of the dispensing region.

With preference, the sheet processing apparatus/processing apparatus for documents of value and the control device are set up to carry out the aforementioned steps for multiple sheet stacks/stacks of documents of value one after another. The control device causes corresponding adjustment devices, e.g. motors or actuators, to carry out the respective movement of the deposition platform and of the lifting platform and of the gripping device.

Aspects of the present disclosure are based preferably on the approach of temporarily storing the further sheet stack/stack of documents of value on the deposition platform until the lifting platform is available to receive the further sheet stack/stack of documents of value, i.e. until the gripping device has removed the (previous) sheet stack/stack of documents of value from the lifting platform and the lifting platform is ready for the transferring of the further sheet stack/stack of documents of value.

This procedure has the advantage that the stacker wheel can already start with the stacking of a further sheet stack/stack of documents of value already while the previous sheet stack/stack of documents of value has been removed from the dispensing region of the sheet processing apparatus/processing apparatus for documents of value specifically by means of the gripper, or even already before this. The effect of the temporary storage of the further sheet stack/stack of documents of value on the deposition platform is that no interruption, or only a short interruption, of the stacking by means of the stacker wheel is necessary, before the stacker wheel can start with the stacking of a further sheet stack/stack of documents of value. This increases the sheet throughput/throughput of documents of value of the stacker wheel or of the sheet processing apparatus/processing apparatus for documents of value.

The deposition platform is set up to be moved away out of the dispensing region (laterally with respect to the stacking direction of the sheet stack/stack of documents of value, e.g. rearwardly). The (lateral) moving away of the deposition platform out of the dispensing region in step g) is carried out in order to be able to stack the sheets/documents of value from the stacking wheel on the lifting platform again. The deposition platform then only needs to be able to perform a one-dimensional lateral movement and does not need to be movable-like the lifting platform-in the stacking direction.

The deposition platform can preferably be displaced only in a direction perpendicular to the stacking direction and counter thereto, e.g. introduced into the dispensing region from the rear and moved away rearward out of the dispensing region. It is also the case that the lifting platform needs to be displaceable only along the stacking direction and counter thereto, but does not need to be displaceable perpendicularly to the stacking direction. This has the advantage that both platforms require a straightforward drive and less space for the movement.

The lifting platform is preferably set up to be lowered downward while the stacker wheel deposits sheets/documents of value on the sheet stack/stack of documents of value formed on the lifting platform.

After step g), the steps a)-g) can be repeated, in particular for the further sheet stack/stack of documents of value and, if appropriate, for sheet stacks/stacks of documents of value that follow it, the further/following sheet stack taking the place of the sheet stack mentioned in step a) during the repetition. When steps a)-g) are being repeated for the further/following sheet stack/stack of documents of value, the stacking is effected as per step a), which is to say on the further/following sheet stack/stack of documents of value that has been transferred from the deposition platform onto the lifting platform. As a result of the repetition, sheets/documents of value are stacked on the further sheet stack/stack of documents of value and on, if appropriate, the sheet stacks/stacks of documents of value that follow it, and the further sheet stack/stack of documents of value and, if appropriate, the sheet stacks/stacks of documents of value that follow it, are removed by means of the gripping device from the lifting platform and out of the dispensing region. The repetition enables a continuous dispensing process of the sheet processing apparatus/processing apparatus for documents of value and thus an even higher throughput of the sheet processing apparatus/processing apparatus for documents of value during the processing of sheets/documents of value.

The sheet stack/stack of documents of value located on the lifting platform in step a) can have been formed by stacking sheets/documents of value by means of the stacker wheel on the lifting platform or by transferring the sheet stack/stack of documents of value from the deposition platform onto the lifting platform as per step g). In step a), the lifting platform can be lowered downward, while the stacker wheel deposits sheets/documents of value on the sheet stack/stack of documents of value.

The introduction of the deposition platform into the dispensing region of the sheet processing apparatus/processing apparatus for documents of value as per step b) can be controlled by a trigger signal, e.g. which is received by the control device, once the sheet stack/stack of documents of value has reached a certain number of sheets/documents of value.

For the introduction of the deposition platform and/or for the transferring of the sheet stack/stack of documents of value from the deposition platform onto the lifting platform, the stacker wheel can be made to pause the stacking operation, although the sheet processing apparatus/processing apparatus for documents of value preferably continues to process sheets/documents of value during the pause in the stacking by the stacker wheel and the sheets/documents of value processed during the pause in stacking are transported to another target location of the sheet processing apparatus/processing apparatus for documents of value, e.g. into another stacker or into another dispensing region or to a shredder of the sheet processing apparatus/processing apparatus for documents of value. The relevant pause in stacking is then, as it were, incorporated only individually for the relevant stacker wheel.

For example, the stacking of sheets/documents of value by means of the stacker wheel onto the sheet stack/stack of documents of value formed on the lifting platform is interrupted before the introduction of the deposition platform. Which is to say, before the introduction of the deposition platform as per step b), step b0) can be carried out:
b0) interrupting the stacking by means of the stacker wheel

The introduction of the deposition platform as per step b) is preferably carried out while the stacking by means of the stacker wheel is interrupted. This has the advantage that a collision of the deposition platform with a sheet/document of value that is currently to be deposited and is falling onto the sheet stack/stack of documents of value is completely ruled out.

The interruption of the stacking by means of the stacker wheel, or the pause in the stacking by the stacker wheel, can be achieved e.g. by interrupting the feed of sheets/documents of value to the stacker wheel, while the stacker wheel is still rotating. This can be effected by stopping the separator of the sheet processing apparatus/processing apparatus for documents of value, or in that the sheets/documents of value processed by the sheet processing apparatus/processing apparatus for documents of value, during the interruption of or pause in the stacking by the relevant stacker wheel, are transported to another target location of the sheet processing apparatus/processing apparatus for documents of value (for examples, see above).

After the introduction of the deposition platform, it is possible to start again with the stacking of the further sheets/documents of value by means of the stacker wheel onto the deposition platform arranged underneath the stacker wheel, in order to form the further sheet stack/stack of documents of value on the deposition platform.

In order to provide space for the introduction of the deposition platform and/or for the accruing sheets/documents of value, it is preferred if the lifting platform together with the sheet stack/stack of documents of value is lowered downward during or after the stacking operation. With preference, the lifting platform is lowered downward (step by step or continuously) while the stacker wheel deposits sheets/documents of value on the sheet stack/stack of documents of value, e.g. on the basis of the signal from a sensor that is positioned under the stacker wheel and detects the sheets/documents of value. The lowering is effected here such that the top side of the stack stays at approximately the same height, in particular at a suitable spacing from the stacker wheel, which is that spacing at which a precise depositing operation is possible. This downward readjustment of the lifting platform together with the growing sheet stack/stack of documents of value has the advantage that the sheets/documents of value can be deposited with greater precision.

While the stacking is interrupted as per step b0), the lifting platform can continue to be lowered downward, in order to provide more space, above the sheet stack/stack of documents of value formed on the lifting platform, for the introduction of the deposition platform. The lifting platform continues to be lowered downward (during/after the interruption of the stacking as per step b0)) e.g. until an introduction condition is met. The introduction condition is e.g. that the lifting platform has reached a certain position or that the upper end of the stack has reached a certain end position, e.g. underneath a light barrier. Once the introduction condition is met, e.g. the end of the stack, during the lowering operation, has reached the end position, the deposition platform is introduced as per step b) into the dispensing region of the sheet processing apparatus/processing apparatus for documents of value and as per step c) further sheets/documents of value are stacked by means of the stacker wheel onto the deposition platform arranged underneath the stacker wheel, in order to form the further sheet stack/stack of documents of value on the deposition platform. The lowering of the lifting platform together with the sheet stack/stack of documents of value can, if appropriate, also be continued after the introduction of the deposition platform as per step b). When there is a correspondingly large spacing between the stacker wheel and the top side of the finished sheet stack/stack of documents of value, it is however also possible to omit a lowering of the lifting platform to introduce the deposition platform.

If there was interruption of the stacking as per step b0), the stacking as per step c) comprises restarting the stacking of further sheets/documents of value by means of the stacker wheel onto the deposition platform arranged underneath the stacker wheel, in order to form a further sheet stack/stack of documents of value on the deposition platform. If there was no interruption of the stacking as per step b0), the stacking as per step c) comprises continuing to stack further sheets/documents of value by means of the stacker wheel onto the deposition platform arranged underneath the stacker wheel, in order to form the further sheet stack/stack of documents of value on the deposition platform.

The deposition platform may have a planar, e.g. plate-like, or rake-like form. The lifting platform may also have a planar, e.g. plate-like, or rake-like form.

The rear boundary of the dispensing region preferably has one or more openings, which complement/s the deposition platform, with the result that the deposition platform can penetrate the opening. For example, the deposition platform has a rake-like form and the rear boundary of the dispensing region has multiple openings, which complement fingers of the rake-like deposition platform. As an alternative, the deposition platform has a planar, e.g. plate-like, form and the complementary opening in the back wall has a corresponding slot-like form.

In particular, the deposition platform and the lifting platform may have mutually complementary, rake-like forms. They each have two or more than two fingers that form a rake. Complementary or complements here means that the fingers of the lifting platform lie in gaps relative to the fingers of the deposition platform, i.e. the fingers of the lifting platform can dip into the gaps between the fingers of the deposition platform, and vice versa. When the deposition platform and the lifting platform have mutually complementary, rake-like forms, meshing between the deposition platform and the lifting platform is possible.

When the deposition platform has a rake-like form, it is preferred if the rear boundary of the dispensing region has multiple openings, which complement the fingers of the rake-like deposition platform. For example, the back wall of the dispensing region may have openings or the rear boundary of the dispensing region may have lattice rods with openings in between that complement the fingers of the rake-like deposition platform. This makes it possible to particularly easily transfer the further sheet stack/stack of documents of value from the deposition platform onto the lifting platform by using the rear boundary to strip the stack off when the deposition platform, or its fingers, is moved laterally out of the dispensing region, or through the rear boundary.

The raising of the lifting platform as per step f) is stopped when the lifting platform is located at the/on the deposition platform, e.g. when the lifting platform is located directly on the underside of the deposition platform, if they both have mutually complementary, rake-like forms, when the lifting platform has penetrated into or through the complementary deposition platform (both meshing with one another). After the lifting platform has been raised up to the deposition platform as per step f), the lifting platform is located at the/on the deposition platform.

When the further sheet stack/stack of documents of value formed on the deposition platform is being transferred onto the lifting platform located at the deposition platform as per step g), the lifting platform can be e.g. directly under the deposition platform or mesh therewith approximately at the same height.

To transfer the further sheet stack/stack of documents of value from the deposition platform onto the lifting platform as per step g), in particular the following two transfer variants are possible:

### 1st Transfer Variant

In the first transfer variant, in step g) the further sheet stack/stack of documents of value is transferred onto the lifting platform by the movement (directed laterally to the stacking direction) away of the deposition platform. In the process, the sheet stack/stack of documents of value located on the deposition platform is stripped off preferably at the rear boundary of the dispensing region, in order to transfer the further sheet stack/stack of documents of value onto the lifting platform. In particular, in the process, the transferring of the further sheet stack/stack of documents of value from the deposition platform onto the lifting platform is achieved by the (lateral) movement away of the deposition platform out of the dispensing region, e.g. through the rear boundary of the dispensing region.

The rear boundary of the dispensing region preferably has one or more openings, which complement the deposition platform. Complementary or complements here means that the openings are shaped such that the deposition platform can penetrate into the openings in the rear boundary. The rear boundary of the dispensing region can be in the form of a back wall with one or more openings or have lattice rods with openings in between.

For example, in the first transfer variant, the lifting platform is raised up to the deposition platform and the raising operation is stopped, as soon as the lifting platform is directly on the underside of the deposition platform or—if they each have mutually complementary, rake-like forms-when the lifting platform meshes with the deposition platform and is at least approximately at the same height as the deposition platform. Then, the deposition platform, on which the further sheet stack/stack of documents of value formed thereon is located, is (laterally) moved away out of the position underneath the stacker wheel, e.g. rearward (laterally means with respect to the stacking direction, e.g. perpendicular to the stacking direction), with the result that the sheet stack/stack of documents of value formed on the deposition platform falls or is transferred onto the lifting platform (located therebelow or meshing at the same height) by the movement away of the deposition platform.

The deposition platform in the first variant, however, does not need to have a rake-like form but may have a planar, e.g. plate-like, form, it being possible for the complementary opening in the back wall in the latter case to have e.g. a slot-like form. In the non-rake-like case, the lifting platform is moved directly onto the underside of the deposition platform, with no meshing occurring between the deposition platform and the lifting platform.

### 2nd Transfer Variant

In the second transfer variant, the deposition platform and the lifting platform have mutually complementary, rake-like forms, and in step g) the further sheet stack/stack of documents of value is transferred from the deposition platform onto the lifting platform by way of an upwardly directed movement of the lifting platform along the stacking direction.

For the transferring of the further sheet stack/stack of documents of value, the lifting platform is thus moved from bottom to top through the complementary rake-like deposition platform, in order to lift the further sheet stack/stack of documents of value off of the deposition platform and thereby transfer it onto the lifting platform. The movement away of the deposition platform in step g) is effected at the same time when the further sheet stack/stack of documents of value is being transferred or (directly) after the further sheet stack/stack of documents of value has been transferred from the deposition platform onto the lifting platform.

In the second variant of the transferring operation, the lifting platform and the complementary, rake-like deposition platform are moved through one another with mutual meshing. The lifting platform is moved upward such that the fingers of its rake enter/pass through the complementary openings between the fingers of the lifting platform, with the result that the lifting platform takes on, or lifts off, the sheet stack/stack of documents of value from the deposition platform. Directly after this transferring operation, the deposition platform (thus separated from the sheet stack/stack of documents of value) is moved away, e.g. laterally.

The stacking of further sheets/documents of value onto the further sheet stack/stack of documents of value by means of the stacker wheel as per step c) can be continued while the sheet stack/stack of documents of value is being transferred (according to the first or second transfer variant) onto the lifting platform. As an alternative, for the transferring operation a short pause in the stacking by the stacker wheel can be incorporated. With preference, the movement away of the deposition platform out of the dispensing region is carried out while further sheets/documents of value are being stacked by means of the stacker wheel on the further sheet stack/stack of documents of value.

The gripping device is designed to take up, between two gripping elements of the gripping device, the sheet stack/stack of documents of value formed on the lifting platform, in order to remove this stack from the dispensing region.

Before the introduction of the gripping device into the dispensing region as per step d), in a step d0) the sheet stack/stack of documents of value deposited on the lifting platform can be precompressed counter to the stacking direction between the lifting platform and the deposition platform. For the precompressing, the sheet stack/stack of documents of value deposited on the lifting platform is clamped and pressed together counter to the stacking direction between the lifting platform and the deposition platform, e.g. until a predetermined spacing between the lifting platform and the deposition platform is reached. Precompressing the sheet stack/stack of documents of value reduces the height, measured in the stacking direction, of the sheet stack/stack of documents of value. As a result of the precompressing, the sheet stack/stack of documents of value is afforded greater stability and can therefore be removed by means of the gripping device more securely. The precompressing of the sheet stack/stack of documents of value can also be continued until the sheet stack/stack of documents of value reaches or falls short of a certain maximum height determined by a maximum opening width of the gripping device, i.e. is less than this maximum height.

To precompress the sheet stack/stack of documents of value formed on the lifting platform, the lifting platform together with the sheet stack/stack of documents of value deposited thereon is raised in the direction toward the deposition platform, with the result that the sheet stack/stack of documents of value butts against the deposition platform from underneath and the raising of the lifting platform is continued after the sheet stack/stack of documents of value butts against the deposition platform, in order to press together, or compress, the sheet stack/stack of documents of value between the lifting platform and the deposition platform counter to the stacking direction.

In the case of precompressing of the sheet stack/stack of documents of value formed on the lifting platform, when the sheet stack/stack of documents of value is being removed by means of the gripping device as per step e) the sheet stack/stack of documents of value is taken out of a clamping fit formed between the lifting platform and the deposition platform.

When the gripping device is being introduced into the dispensing region as per step d), the gripping device takes up the sheet stack/stack of documents of value between the two gripping elements of the gripping device, the latter preferably compressing the taken-up sheet stack/stack of documents of value counter to the stacking direction. In the case of the precompressing as per step d0), the compressing by means of the gripping device is a further compressing operation carried out in addition to the precompressing. During the compressing, the gripping device presses the sheet stack/stack of documents of value together counter to the stacking direction, e.g. down to a predetermined stack height or until the gripping device exerts a particular gripping force, or a certain opposing force exerted by the sheet stack/stack of documents of value is achieved.

The stacking of further sheets/documents of value by means of the stacker wheel onto the further sheet stack/stack of documents of value located on the deposition platform, as per step c), is preferably started before the introduction of the gripping device as per step d), i.e. also before the removal of the sheet stack/stack of documents of value located on the lifting platform from the dispensing region by means of the gripping device as per step e). This has the advantage that the stacking by means of the stacker wheel only needs to be interrupted briefly and for the stacking of the further sheet stack/stack of documents of value it is not necessary to wait for the removal of the (previous) sheet stack/stack of documents of value. While the gripping device is being introduced into the dispensing region (step d)) and/or while the sheet stack/stack of documents of value formed on the lifting platform is being removed by the gripping device from the dispensing region (step e)), further sheets/documents of value can be stacked, as per step c), onto the further sheet stack/stack of documents of value located on the deposition platform.

With preference, the gripping device, after the removal of the sheet stack/stack of documents of value as per step e), places the removed sheet stack/stack of documents of value in a further step e*) into a sheet container/container for documents of value, this container being located within reach of the gripping device. When steps a)-g) are being repeated, in particular when removal step e) is being repeated, the further sheet stack/stack of documents of value removed from the dispensing region is placed by the gripping device e.g. into the same sheet container/container for documents of value as the sheet stack/stack of documents of value (that preceded it), in particular into a different storage area of this sheet container/container for documents of value than the sheet stack/stack of documents of value (that preceded it).

With preference, the control device and/or the sheet processing apparatus/processing apparatus for documents of value is set up to trigger the aforementioned steps. The control device for this has e.g. a processor, which executes software for triggering the aforementioned steps and communicates with the correspondingly activated adjusting devices of the components to be moved (e.g. lifting platform, deposition platform, gripping device). The control device communicates e.g. also with a control device of the sheet processing apparatus/processing apparatus for documents of value, the latter control device controlling the processing, in particular transportation and stacking, of the sheets/documents of value.

In particular, the control device and/or the sheet processing apparatus/processing apparatus for documents of value is set up to cause
the stacking of sheets/documents of value by means of the stacker wheel onto the sheet stack/stack of documents of value formed on the lifting platform to be interrupted before the introduction of the deposition platform, and, if appropriate, while the stacking is interrupted, the lifting platform to continue to be lowered downward, and/or,
after the introduction of the deposition platform, the stacking of the further sheets/documents of value by means of the stacker wheel onto the deposition platform arranged underneath the stacker wheel to be started, in order to form the further sheet stack/stack of documents of value on the deposition platform, and/or,
during and/or after the stacking of the sheets/documents of value onto the sheet stack/stack of documents of value located on the lifting platform, the lifting platform to be lowered downward, in particular while the stacker wheel deposits sheets/documents of value on the sheet stack/stack of documents of value, and/or
the gripper device to take up the sheet stack/stack of documents of value between two gripping elements of the gripping device and compress the taken-up sheet stack/stack of documents of value counter to the stacking direction, and/or,
before the introduction of the gripping device into the dispensing region, the sheet stack/stack of documents of value deposited on the lifting platform to be precompressed counter to the stacking direction between the lifting platform and the deposition platform, and during the precompressing operation the sheet stack/stack of documents of value deposited on the lifting platform to be clamped and pressed together between the lifting platform and the deposition platform, the lifting platform being raised e.g. together with the sheet stack/stack of documents of value deposited thereon in the direction toward the deposition platform, in order to clamp the sheet stack/stack of documents of value between the lifting platform and the deposition platform, and the raising of the lifting platform to be continued after the clamping of the sheet stack/stack of documents of value, in order to compress the sheet stack/stack of documents of value between the lifting platform and the deposition platform counter to the stacking direction, and/or
the introduction of the gripping device and the removal of the sheet stack/stack of documents of value by means of the gripping device and, if appropriate, also the precompressing to be carried out while the further sheet stack/stack of documents of value is being formed, or stacked, on the deposition platform, and/or
the stacking of sheets/documents of value by means of the stacker wheel on the further sheet stack/stack of documents of value located on the deposition platform to be started before the introduction of the gripping device and/or to be started before the removal of the sheet stack/stack of documents of value located on the lifting platform from the dispensing region by means of the gripping device.

The sheet processing apparatus may be an apparatus for processing sheet-like electrode elements designed to form electrode-element stacks. The sheets mentioned in this application are sheet-like electrode elements in that case. The term sheet-like electrode element is understood to mean an electrode element which has a much greater surface area than it does thickness, e.g. its length and width are at least 10 times the thickness.

The sheet-like electrode elements are e.g. electrode elements for an electrochemical energy store or an energy converter. In the electrode-element stack, similar sheet-like electrode elements, but also different sheet-like electrode elements, may be stacked. The sheet-like electrode elements are e.g. monocells, anodes, cathodes, separators, anode-separator combinations, cathode-separator combinations or anode-separator-cathode-separator combinations.

The processing of the sheet-like electrode elements in the sheet processing apparatus designed to form electrode-element stacks can comprise transporting and stacking the sheet-like electrode elements and, if appropriate, verifying the sheet-like electrode elements. Correspondingly, the apparatus may have one or more transportation devices, which are used to transport the sheet-like electrodes (e.g. past sensors for verifying them) and to transport them to the stacker wheel, which stacks the sheet-like electrode elements. The apparatus is e.g. one used in the production of sheet-like electrode elements or battery cells.

The sheet processing apparatus may be a processing apparatus for documents of value, which is set up to process documents of value, in particular to verify and, if appropriate, sort documents of value. It has e.g. one or more transportation devices, which are used to transport the documents of value past sensors for verifying the documents of value and to transport the latter to the stacker wheel, which stacks the processed documents of value. The processing apparatus for documents of value has e.g. also a separating device, which is used to separate the documents of value from a starting stack and feed them to one of the transportation devices. The respective stack of the processed documents of value is dispensed in the dispensing region of the processing apparatus for documents of value. The documents of value are e.g. banknotes, checks, identity cards, but the invention relates to any type of documents of value.

The control device may be set up to control the gripping of the sheet stack/stack of documents of value deposited in the dispensing region and the depositing of the sheet stack/stack of documents of value into the sheet container/container for documents of value by means of the gripping device.

The sheet container/container for documents of value has e.g. at least two receiving portions and the control device may be designed to control the gripping device and/or a movement of the sheet container/container for documents of value such that multiple sheet stacks/stacks of documents of value dispensed by the sheet processing apparatus/processing apparatus for documents of value are deposited one after another into different receiving portions of the same sheet container/container for documents of value.

The sheet processing apparatus/processing apparatus for documents of value may also have one or more filling apparatuses which is/are set up to fill sheet containers/containers for documents of value with the sheet stacks/stacks of documents of value dispensed from the sheet processing apparatus/processing apparatus for documents of value. This filling apparatus/es can be moved up to and/or docked at and/or fastened to the sheet processing apparatus/processing apparatus for documents of value.

The control device may also be set up to cause the gripping device of the sheet processing apparatus/processing apparatus for documents of value to grip a (respective) sheet stack/stack of documents of value deposited in the dispensing region of the sheet processing apparatus/processing apparatus for documents of value, to remove this stack from the dispensing region and deposit it into a receiving portion of a sheet container/container for documents of value positioned in the filling region of the filling apparatus, in order to fill the sheet container/container for documents of value with the sheet stack/stack of documents of value (and, if appropriate, further sheet stacks/stacks of documents of value).

The gripping device may be fastened to the sheet processing apparatus/processing apparatus for documents of value or be a separate apparatus, e.g. a robot gripper.

Further advantages, features and application possibilities of the present invention will become apparent from the following description in association with the figures, in which:

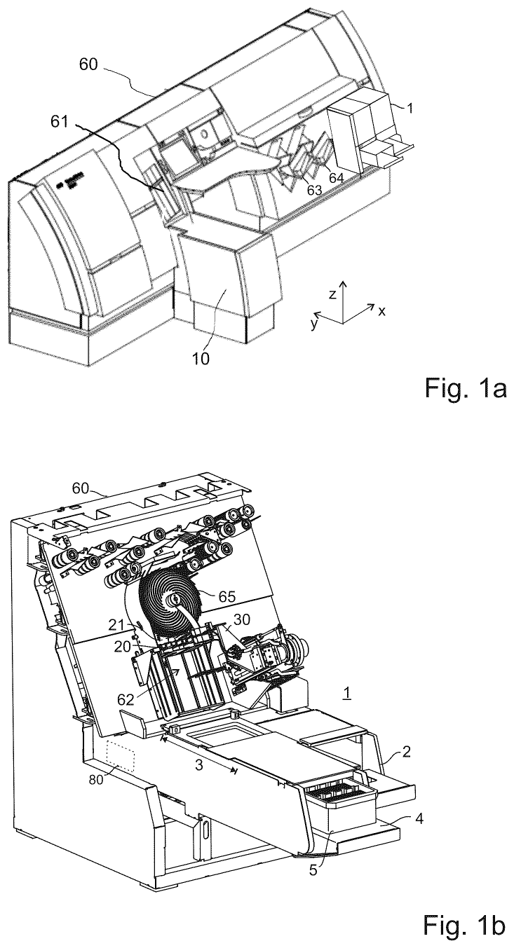

FIG. 1a shows an example of a processing apparatus for documents of value,

FIG. 1b shows a detail view of a processing apparatus for documents of value without a cover in the region of the dispensing region according to one exemplary embodiment,

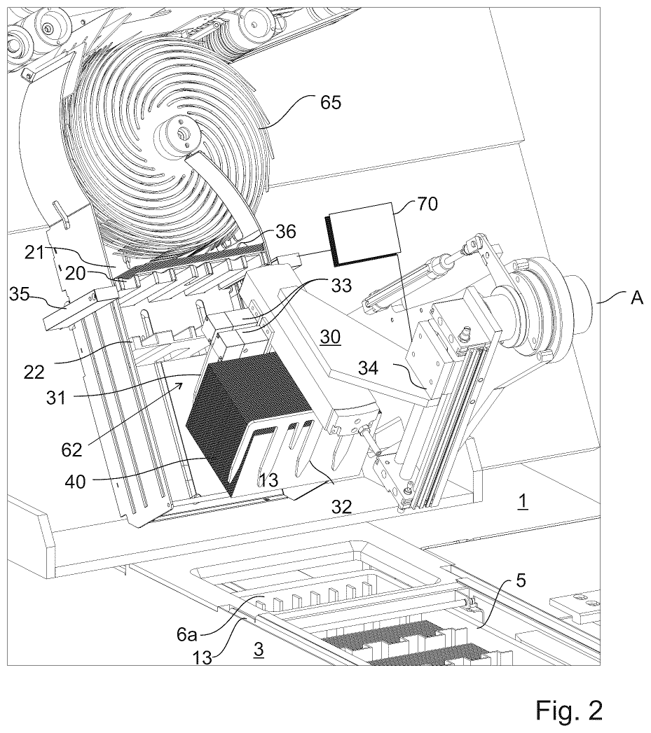

FIG. 2 shows a snapshot during the removal of a stack of documents of value from the processing apparatus for documents of value by means of a gripping device,

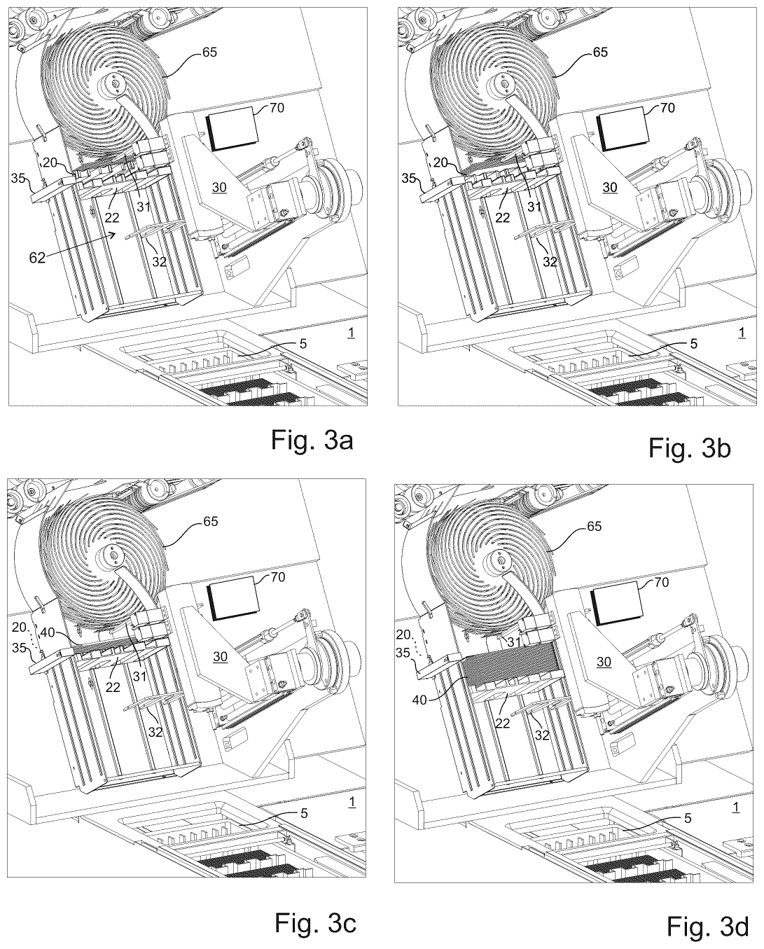

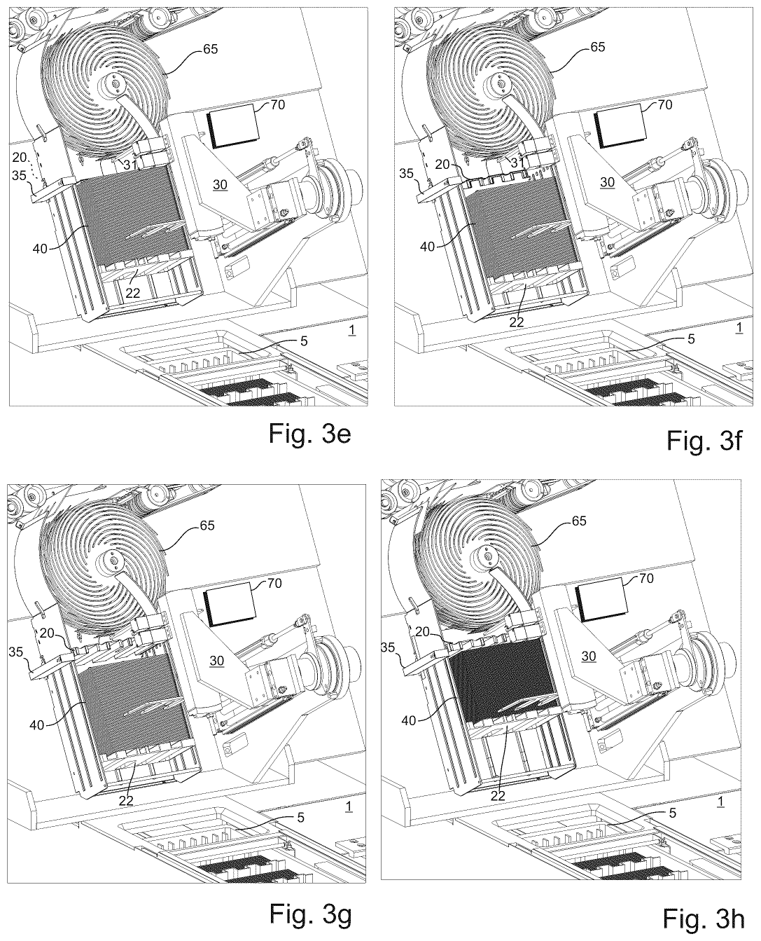

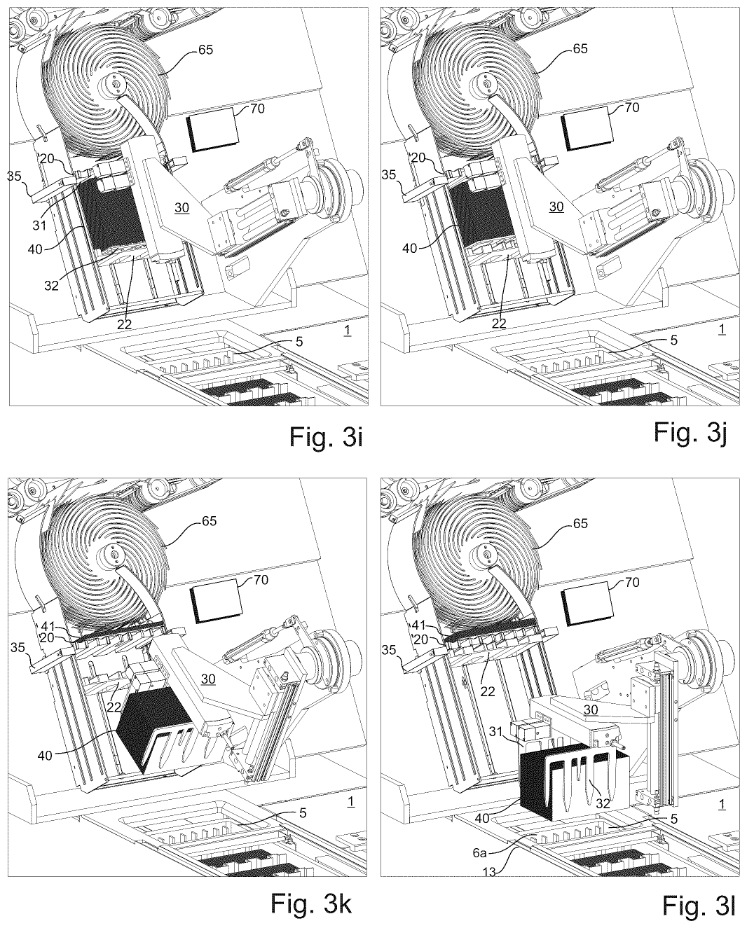

FIG. 3a-1 show steps for dispensing a stack of documents of value and removing it by way of a gripping device according to an exemplary embodiment,

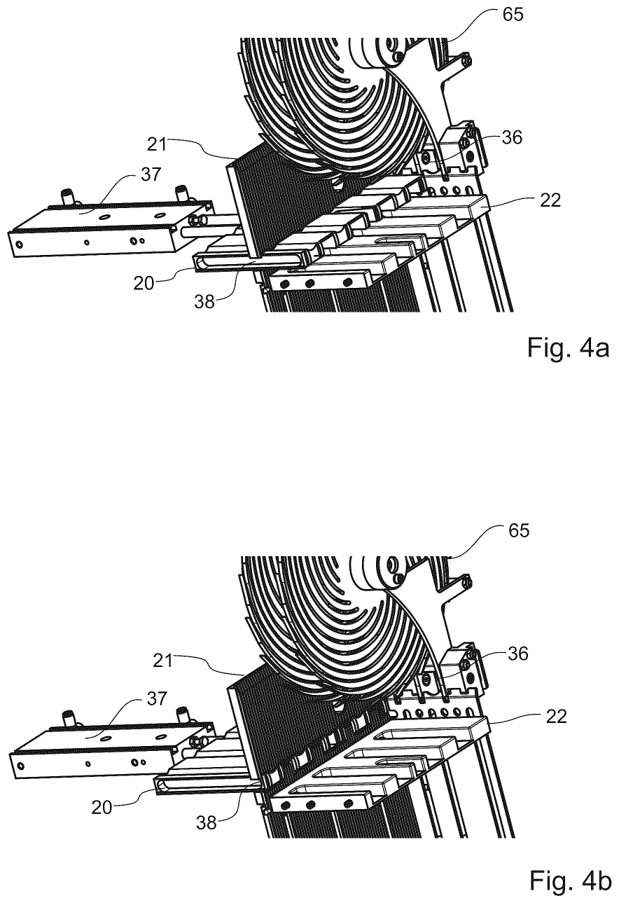

FIG. 4a-b show the movement of the deposition platform out of the dispensing region.

FIG. 1a shows a processing apparatus 60 for documents of value, according to an exemplary embodiment, which is set up to sort, count and/or verify the documents of value and, to this end, to provide processed documents of value for removal by way of a gripping device (which is located under the cover of the filling apparatus 1) or, if appropriate, dispense them into one of its dispensing compartments 63, 64. The gripping device can transport the removed stack of documents of value e.g. into a container for documents of value, this container being provided in the filling apparatus 1. The documents of value can be inserted into the insertion compartment 61 of the processing apparatus 60 for documents of value automatically using an inserting module 10, in which documents of value are removed in stacks from containers for documents of value. The processing apparatus 60 for documents of value is used for example in a cash center.

The documents of value provided in the insertion compartment 61 of the processing apparatus 60 for documents of value are withdrawn individually from the insertion compartment using a separator and transported (not shown) in the processing apparatus 60 for documents of value along a transport path past one or more sensors. In the process, physical properties of the documents of value are detected and converted into corresponding sensor signals, which are used by a control and evaluation device of the processing apparatus 60 for documents of value to identify and verify the documents of value, for example in terms of quality, denomination, authenticity or state. Deflectors arranged along the transport path are controlled such that the documents of value are transported depending on the result of the identification or verification to different dispensing compartments 63, 64 or to the dispensing region 62, from which they are removed by means of the gripping device 30; cf. FIG. 1b. Adjoining the dispensing compartments 63, 64 there may be e.g. a banderoling device and/or packaging device for the formed stacks of documents of value.

The documents of value transported to the dispensing region 62 may be e.g. rejected documents of value, which are rejected by the processing apparatus 60 for documents of value during the verification, while documents of value accepted during the verification are deposited into the dispensing compartments 63, 64. As an alternative, it is however also possible for banknotes accepted during the verification to be transported to the dispensing region 62. It is also possible for multiple such dispensing regions 62 to be installed on one processing apparatus 60 for documents of value. Upstream of the dispensing compartments 63, 64 and upstream of the dispensing region 62 of the processing apparatus 60 for documents of value there is a respective stacker wheel 65 in the processing apparatus 60 for documents of value, and the stacker wheels can be used to stack the documents of value for their dispensing.

The filling apparatus 1 is used for filling containers 5 for documents of value with the stacks of documents of value, e.g. the stack 40 of documents of value, provided in the dispensing region 62 and deposited in the dispensing region 62 of the processing apparatus 60 for documents of value. For this, an (empty or partly full) container 5 for documents of value that is to be filled is manually or automatically fed to the filling apparatus 1 at its feed interface 2, which is in the form of a feed opening; cf. FIG. 1b. The container 5 is subdivided by separating elements into multiple receiving portions, of which one receiving portion 6a is shown in FIG. 2. The fed container 5 is then transported using transportation devices of the filling apparatus 1 into a filling region 3 of the filling apparatus 1, and the container 5 is filled with stacks of documents of value in the filling region; cf. FIG. 2. After the filling operation, the filling apparatus transports the container 5 filled with stacks of documents of value from the filling region 3 to the dispensing interface 4, in the form of a dispensing opening, of the filling apparatus, in order to provide the container 5 for manual removal from the filling apparatus 1, or for automatic transportation away of the filled container, if appropriate by means of a conveyor belt. The movement of the container 5 through the filling apparatus is controlled by a control device 80 of the filling apparatus; cf. FIG. 1b. The transportation path of the containers in the filling apparatus 1 may be formed such that the containers are deflected on their transportation path from the feed interface to the dispensing interface twice (horizontally or vertically) by 90°.

The containers 5 to be filled each have one or more receiving portions, which are designed to each receive a stack of documents of value. With preference, the containers, or receiving portions, are open on their top side, with the result that stacks of documents of value can be placed into the container from above. The container 5 can have at least two receiving portions along its longitudinal extent and the control device 70 may be designed to control the gripping device 30 and, if appropriate, the transportation device of the filling apparatus such that, one after another, multiple stacks of documents of value dispensed by the processing apparatus for documents of value, i.e. formed one after another in a deposition on the lifting platform 22, are deposited in different receiving portions of the same container 5 positioned in the filling region.

The gripping device 30 is controlled by a control device 70 and has two gripping elements 31, 32, which can be moved away from and toward one another by means of a motor, in order to grip the respective stack of documents of value between the two gripping elements 31, 32; cf. FIG. 2. In order to be able to grip considerably differently sized stacks of documents of value and place them in the container, different opening widths of the gripping device can be provided for the moving-apart of the gripping elements of the gripping device.

The control device 70 can also be designed to control the transportation device of the filling apparatus 1. If different container types that have receiving portion/s in different positions along the longitudinal direction of the container and/or receiving portion/s of different lengths are used, the control device 70 and/or the control device of the processing apparatus for documents of value may have information available about the predetermined position and, if appropriate, length of the receiving portions depending on the container type. The information about the container type of the respective container to be filled can be preset, or set by an operator (if appropriate, for each container individually), or ascertained automatically on the basis of identification data of the container (if appropriate, for each container individually). The control device 70 then controls the opening width of the gripping elements on the basis of the container type and, if appropriate, on the basis of the respective receiving portion to be filled (if, in the case of the container type, differently sized receiving portions as is known are present).

In the dispensing region 62 of the processing apparatus 60 for documents of value, underneath the stacker wheel 65 there is a rake-like lifting platform 22, on which documents of value can be stacked by the stacker wheel 65 to form a stack of documents of value, and a rake-like deposition platform 20 is temporarily introduced above the lifting platform, cf. FIG. 2, and on this deposition platform documents of value can be temporarily stacked by the stacker wheel 65.

An exemplary embodiment for dispensing the stack 40 of documents of value out of the processing apparatus 60 for documents of value and removing the stack by way of the gripping device is described in the following FIGS. 3a-1.

FIG. 3a shows the dispensing region 62 at a point in time when some documents of value have been stacked by the stacker wheel 65 on the deposition platform 20 to form a stack of documents of value and the lifting platform 22 is just moving upward to the deposition platform 20.

Optionally, a short pause in the stacking by the stacker wheel 65 is incorporated, in order to transfer the stack of documents of value as securely as possible from the lifting platform 22 onto the deposition platform 20. To this end, the control device 70 may cause a pause in the stacking by the stacker wheel 65, once the lifting platform 22 has arrived directly on the underside of the deposition platform 20, e.g. as a result of a corresponding signal to the control device of the processing apparatus 60 for documents of value. Just after the start of this pause in the stacking by the stacker wheel 65, the control device 70 then causes the deposition platform 20 to be withdrawn by means of an adjusting device 37, e.g. a motor, rearward into the apparatus 60, in order to strip off the further stack 40 of documents of value, deposited on the deposition platform, at a back wall 21 which belongs to the dispensing region 62 and is located behind the deposition platform 20 (cf. FIG. 2) and thus deposit the stack from the deposition platform 20 onto the underlying lifting platform 22. FIG. 4a, 4b show the movement back of the deposition platform through the back wall 21 of the dispensing region 62 (stack of documents of value not shown). FIG. 4a and FIG. 3b show the moment when the deposition platform 20 has been moved away halfway rearward, and FIG. 4b shows the point in time when the deposition platform 20 has been moved out of the dispensing region 62. In order to enable the lateral movement away of the deposition platform 20 rearward through the back wall 21 of the dispensing region 62, the back wall has openings 38: cf. FIG. 4a, b, which complement the fingers of the rake-like deposition platform 20, with the result that it can pass through the openings 38. In FIG. 3c, the deposition platform 20 has already been moved away completely rearward and is located behind the back wall 21 of the dispensing region 62. The stack 40 of documents of value was thus transferred to the lifting platform 22.

Once the stack of documents of value was transferred to the lifting platform 22, the optional pause in the stacking by the stacker wheel 65 ends and the stacker wheel 65 continues to stack documents of value on the stack 40 of documents of value that is deposited on the lifting platform. To this end, the control device 70 sends a corresponding signal to the controller of the processing apparatus 60 for documents of value, which then transports processed documents of value to the stacker wheel 65 again.

In order to provide space for the accruing documents of value, the lifting platform 22 together with the stack 40 of documents of value is lowered downward step by step or continuously during the stacking operation by means of the stacker wheel 65; cf. FIG. 3d. This readjustment operation is controlled by the control device 70 on the basis of the signal from capacitive sensors 36, which are arranged on the side wall of the dispensing region 62 directly underneath the stacker wheel 65 and detect the stack 40 of documents of value; cf. FIG. 2.

The documents of value then continue to be stacked by means of the stacker wheel 65 onto the stack 40 of documents of value until an introduction condition is met. The introduction condition used can be e.g. that the stack 40 of documents of value has at least a certain number of documents of value (e.g. 500) and/or that the lifting platform 22 in being lowered has reached a certain position in the lower portion of the dispensing region 62, e.g. a lower stop, and/or that the upper stack end of the stack 40 of documents of value is located below a certain position, which is monitored using light barriers 35; cf. FIG. 3c. Once the introduction condition is met, the deposition platform 20 is introduced into the dispensing region 62 of the apparatus for processing documents of value. For this, the deposition platform 20 is brought, from the rear through the rear wall of the dispensing region 62, into its position directly underneath the stacker wheel 65; cg. FIG. 3f.

For the lateral introduction of the deposition platform 20, preferably a further short pause in the stacking by the stacker wheel 65 is incorporated, in order to avoid a lateral collision of the laterally introduced deposition platform 20 with documents of value currently to be deposited. For example, the processing apparatus 60 for documents of value pauses the stacking by the stacker wheel 65 once the stack 40 of documents of value has at least a certain number of documents of value (e.g. 500). As an alternative, the further pause in stacking can, however, also be omitted, e.g. when the deposition platform 20 can be brought into position very quickly and/or the precise point in time when the introduction takes place is deliberately set between two documents of value to be stacked by the stacker wheel 65.

This optional pause in stacking for the introduction of the deposition platform 20 and/or the aforementioned optional pause in stacking for transferring the stack of documents of value from the deposition platform 20 onto the lifting platform 22 can involve a pause for separating and/or processing by the processing apparatus for documents of value. With preference, the processing apparatus 60 for documents of value continues the separation and processing of documents of value, however, during the pause in the stacking by the stacker wheel 65 and transports the documents of value separated and processed during the pause in stacking to another target location of the processing apparatus 60 for documents of value, e.g. into another stacker/into another dispensing region/to a shredder of the processing apparatus 60 for documents of value. The relevant pause in stacking is then, as it were, incorporated only individually for this stacker wheel 65.

After the lateral introduction of the deposition platform 20 underneath the stacker wheel 65: cf. FIG. 3g, further documents of value can be stacked by means of the stacker wheel 65, but then onto the deposition platform 20 (instead of the lifting platform 22) arranged underneath the stacker wheel, in order to form a further stack 41 of documents of value on the deposition platform 20.

The lowering of the lifting platform 22 together with the stack 40 of documents of value located thereon is ended once the lifting platform 22 in being lowered has reached a certain position in the lower portion of the dispensing region 62, e.g. a lower stop, and/or once the upper stack end of the stack 40 of documents of value is located below the certain position, which is monitored using light barriers 35; cf. FIG. 3f, 3g. The stack 40 of documents of value is moved downward using the lifting platform 22 and thus provided for removal by the gripping device 30. Then, the stack 40 of documents of value is removed from the dispensing region 62 by means of the gripping device 30.

Before the removal of the stack 40 of documents of value by means of the gripping device 30, it is however optionally also possible to precompress the stack 40 of documents of value formed on the lifting platform. This precompressing step is carried out e.g. when it is known that the number of known documents of value in the stack 40 of documents of value is tending toward too many (e.g. in the case of reject documents of value) and the stack height could as a result be higher than the gripping device can grip. For the precompressing operation, the lifting platform 22 together with the stack 40 of documents of value deposited thereon is moved up again in the direction toward the deposition platform 20, until the stack 40 of documents of value presses against the deposition platform 20 from underneath, such that the stack of documents of value is compressed between the deposition platform 20 and the lifting platform 22; cf. FIG. 3h. The precompressing reduces the stack height to an extent which is smaller than the maximum opening width of the gripping elements 31, 32 of the gripping device 30. During the precompression, it is possible to continue the stacking of the further documents of value by the stacker wheel 65 onto the deposition platform 20.

To remove the stack 40 of documents of value, the gripping device 30 engages with its upper gripping element 31 in the grooves of the rake-like deposition platform 20 and with its lower gripping element 32 into the grooves of the rake-like lifting platform 22; cf. FIG. 3i. In order to securely take up the stack of documents of value, the gripping device 30 compresses the already precompressed stack of documents of value somewhat further, e.g. until a certain opposing force exerted by the stack of documents of value is reached; cf. FIG. 3j. The gripping device 30, by means of its gripping elements 31, 32, takes the stack 40 of documents of value deposited on the lifting platform 22 forward out of the dispensing region 62 and removes the stack 40 of documents of value in this way from the lifting platform 22 and out of the dispensing region 62.

By means of a downward pivoting movement (by rotation about the axis A; cf. FIG. 2, FIG. 3k), the gripping device 30 brings the stack 40 of documents of value into a lowered position directly above the filling position 13 of a container 5 for documents of value that is arranged in the filling region 3; cf. FIG. 3l. Beforehand, that receiving portion 6a of the container for documents of value into which the stack of documents of value is to be placed was positioned at the filling position 13.

The lifting platform 22, freed of the stack of documents of value, in the meantime moves upward again in the direction toward the deposition platform 20; cf. FIG. 3k, 31. While the stacks 40 are being removed from the dispensing region 62 by the gripping device 30 and the lifting platform is moving upward, it is possible to continue stacking further documents of value on the deposition platform 20 to form the further stack 41 of documents of value; cf. FIG. 3k, 31.

When the lifting platform 22 has arrived at the top at the deposition platform 20, the further stack 41 of documents of value can be transferred from the deposition platform 20 onto the lifting platform 22, as was described above in relation to FIG. 3b, 3c.

The process described for the stack 40 of documents of value is then repeated for the further stack 41 of documents of value, in order to deposit even more documents of value onto the further stack 41 of documents of value and then remove the finished stack 41 of documents of value by means of the gripping device 30 from the lifting platform 22 and out of the dispensing region 62 and place it into the container 5.

When the gripping device has reached the lowered position, it is lowered using a linear drive 34: cf. FIG. 2, from the lowered position shown in FIG. 3l downward into the receiving portion 6a of the container for documents of value, with the two gripping elements 31, 32 together with the stack 40 of documents of value dipping into the receiving portion 6a. The lowering movement is stopped and the two gripping elements 31, 32 slightly opened, in order to release the stack 40 of documents of value and thereby deposit it into the receiving portion 6a of the container 5 for documents of value; cf. FIG. 3f. Then, the gripping device is moved upward out of the container 5 again and is available for having the next stack of documents of value placed therein, this next stack being the next one deposited on the lifting platform 22. The placement of the next stack of documents of value into the other receiving portions 6b-f of the container 5 for documents of value is effected analogously.

When the stack 40 of documents of value is being released, the gripping elements 31, 32 are moved apart from one another to an opening width, which is the same or somewhat smaller than the length of the respective receiving portion 6a-f along the longitudinal direction of the container 5. The separating elements 6 (cf. FIG. 3a) present in the container 5 can have grooves on their side facing toward the placed-in stack of documents of value, and the gripping elements 31, 32 dip into these grooves to release the stack of documents of value, although are intended to make gentle contact therewith in so doing.

In order to make it possible to place differently sized stacks 40 of documents of value into differently sided receiving portions, different opening widths may be provided for the moving away from one another of the gripping elements 31, 32 when the respective stack 40 of documents of value is being released. For example, it may be provided that—in the same or in different containers 5—receiving portions of multiple different lengths may be used. The control device 70 of the gripping device then controls the movement away from one another of the gripping elements 31, 32 such that the opening width on release of the stack of documents of value is adapted to the length of the respective receiving portion. The opening width on release of the stack 40 of documents of value is preferably selected such that the gripping elements 31, 32 on being moved away from one another do not butt against the separating elements 6 of the container 5. The opening width of the gripping elements can be varied continuously or discretely. For example, the opening width can be varied continuously by a stepper motor for the movement of the gripping elements 31, 32. In this exemplary embodiment, for the gripping device 30, however, a discrete number of opening widths is predefined by multiple mechanical rams, which mechanically delimit the movement away from one another of the gripping elements 31, 32 on release of the stack 40 of documents of value and the position of which is controlled by the control device 70 using stop magnets 33; cf. FIG. 2a.

A step-by-step movement of a banknote container 5 by the filling apparatus 1 makes it possible, by means of the gripping device 30, to place multiple stacks 40 of documents of value one after another from the processing apparatus for documents of value into the different receiving portions 6a, 6b, etc. of the container 5 for documents of value. After the receiving portion 6a is filled, the container 5 is advanced until the receiving portion 6b is positioned at the filling position 13. Then, the next stack of documents of value from the processing apparatus 60 for documents of value is placed into the receiving portion 6b, as was described in connection with FIG. 3a-1. In this way, the receiving portions 6a-f of the container for documents of value are filled one after another with stacks of documents of value.

Owing to the step-by-step transportation of the different receiving portions 6a-f to the same filling position 13, the gripping device 30 does not need to approach different filling positions, but instead can always approach the same predetermined filling position 13 to fill the different receiving portions 6a-f. The gripper movement is therefore less complex and therefore needs less space. When all of the receiving portions, or an intended number of receiving portions, of the container 5 are filled, the container 5 is transported in the dispensing transportation direction (−y) along the dispensing portion 14 as far as the dispensing interface 4 and can there be manually or automatically removed.

The respective container positioned in the filling region can be transported by means of a transportation device of the filling apparatus step by step along a transportation direction through the filling apparatus 1 such that successive different (e.g. two or more) receiving portions of the same container are arranged at the predetermined filling position 13 and temporarily remain there, until the gripping device 30 has deposited a respective stack of documents of value in the respective receiving portions of the container.

1.-15. (canceled)

16. A method for forming sheet stacks, in a dispensing region of a sheet processing apparatus, comprising the following steps:
a) stacking sheets by means of a stacker wheel of the sheet processing apparatus onto a sheet stack located on a lifting platform,
b) introducing a deposition platform into the dispensing region of the sheet processing apparatus, wherein the deposition platform is introduced such that the deposition platform is arranged in a position which is underneath the stacker wheel and lies above the uppermost sheet of the sheet stack formed on the lifting platform,
c) stacking further sheets by the stacker wheel onto the deposition platform arranged underneath the stacker wheel, in order to form a further sheet stack on the deposition platform,
d) introducing a gripping device into the dispensing region of the sheet processing apparatus, in order to take up, by the gripping device, the sheet stack formed on the lifting platform,
e) removing, by the gripping device, the sheet stack formed on the lifting platform from the dispensing region of the sheet processing apparatus,
and after the removal of the sheet stack:
f) raising the lifting platform up to the deposition platform, and
g) transferring the further sheet stack formed on the deposition platform onto the lifting platform located on the deposition platform and moving the deposition platform away out of the dispensing region.

17. The method according to claim 16, wherein, after step g), steps a)-g) are repeated.

18. The method according to claim 16, wherein the stacking of sheets by the stacker wheel onto the sheet stack formed on the lifting platform is interrupted before the introduction of the deposition platform, and, after the introduction of the deposition platform, the stacking of the further sheets by the stacker wheel onto the deposition platform arranged underneath the stacker wheel is started, in order to form the further sheet stack on the deposition platform.

19. The method according to claim 16, wherein, during and/or after the stacking of the sheets on the lifting platform, the lifting platform is lowered downward, while the stacker wheel deposits sheets on the sheet stack.

20. The method according to claim 18, wherein, while the stacking is interrupted, the lifting platform is lowered downward,
wherein the lifting platform is lowered downward until an introduction condition is met and, once the introduction condition is met, the deposition platform is introduced as per step b) into the dispensing region of the sheet processing apparatus and then, as per step c), the further sheets are stacked by the stacker wheel onto the deposition platform arranged underneath the stacker wheel, in order to form the further sheet stack on the deposition platform.

21. The method according to claim 16, wherein the rear boundary of the dispensing region has one or more openings, which complement/s the deposition platform.

22. The method according to claim 16, wherein in step g) the further sheet stack is transferred onto the lifting platform by moving the deposition platform away,
wherein the sheet stack located on the deposition platform is stripped off at a rear boundary of the dispensing region, in order to transfer the further sheet stack onto the lifting platform.

23. The method according to claim 16, wherein the deposition platform and the lifting platform have mutually complementary, rake-like forms, and in step g) the further sheet stack is transferred from the deposition platform onto the lifting platform by way of an upwardly directed movement of the lifting platform along the stacking direction.

24. The method according to claim 16, wherein, when the gripping device is being introduced in step d), the gripping device takes up the sheet stack between two gripping elements of the gripping device and compresses the taken-up sheet stack counter to the stacking direction.

25. The method according to claim 16, wherein, before the introduction of the gripping device into the dispensing region as per step d), in a step d0) the sheet stack deposited on the lifting platform is precompressed counter to the stacking direction between the lifting platform and the deposition platform, and during the precompressing operation the sheet stack deposited on the lifting platform is clamped and possibly pressed together between the lifting platform and the deposition platform.

26. The method according to claim 25, wherein, to precompress the sheet stack formed on the lifting platform, the lifting platform together with the sheet stack deposited thereon is raised in the direction toward the deposition platform, in order to clamp the sheet stack between the lifting platform and the deposition platform, and the raising of the lifting platform is continued after the sheet stack has been clamped, in order to compress the sheet stack between the lifting platform and the deposition platform counter to the stacking direction.

27. The method according to claim 16, wherein, before the introduction of the gripping device as per step d), the stacking of further sheets by the stacker wheel onto the further sheet stack located on the deposition platform, as per step c), is started.

28. The method according to claim 17, wherein, after the removal of the sheet stack as per step e), the gripping device in a further step e*) places the removed sheet stack into a sheet container located within reach of the gripping device,
wherein, when steps a)-g) are being repeated, when removal step e) is being repeated, the further sheet stack removed from the dispensing region is placed by the gripping device into the same sheet container as the sheet stack.

29. The method according to claim 16, wherein the deposition platform can be displaced only in a direction perpendicular to the stacking direction and counter thereto, and/or
wherein the lifting platform can be displaced only along the stacking direction and counter thereto.

30. A sheet processing apparatus, for forming sheet stacks, in a dispensing region of the sheet processing apparatus, comprising a stacker wheel, a lifting platform, a deposition platform, a control device and a gripping device,
wherein the sheet processing apparatus is set up for the stacker wheel to stack sheets processed by the sheet processing apparatus onto a sheet stack which is located on the lifting platform and underneath the stacker wheel in the dispensing region of the sheet processing apparatus, and
the control device is set up to cause, at a point in time while the stacking by the stacker wheel is interrupted, the deposition platform to be introduced into the dispensing region of the sheet processing apparatus such that the deposition platform is arranged in a position which is underneath the stacker wheel and lies above the uppermost sheet of the sheet stack formed on the lifting platform,
the sheet processing apparatus is set up to stack, after the introduction of the deposition platform into the dispensing region, further sheets processed by the sheet processing apparatus onto the deposition platform arranged underneath the stacker wheel, in order to form a further sheet stack n the deposition platform,
the control device is set up to cause
the gripping device to be introduced into the dispensing region of the sheet processing apparatus, to take up the sheet stack formed on the lifting platform and to remove this sheet stack from the dispensing region of the sheet processing apparatus, and,
after the removal of the sheet stack formed on the lifting platform, the lifting platform to be raised up to the deposition platform, and
the deposition platform to be moved away out of the dispensing region, and
the further sheet stack formed on the deposition platform to be transferred onto the lifting platform located on the deposition platform.
